(19) United States
(12) Patent Application Publication
(10) Pub. No.: US 2009/0303624 A1
(43) Pub. Date: Dec. 10, 2009

(54) TERAHERTZ-BAND OPTICAL COMPONENT

(75) Inventors: Takashi Fujii, Otsu-shi (JP); Yoshifumi Sano, Kyoto-shi (JP); Kazuyuki Hirao, Kyoto-shi (JP)

Correspondence Address: DICKSTEIN SHAPIRO LLP, 1177 Avenue of the Americas, New York, NY, 10036-2714, US

(73) Assignee: MURATA MANUFACTURING CO., LTD, Nagaokakyo-Shi (JP)

(21) Appl. No.: 12/486,394

(22) Filed: Jun. 17, 2009

Related U.S. Application Data
(63) Continuation of application No. PCT/JP2007/074118, filed on Dec. 14, 2007.

(30) Foreign Application Priority Data
Dec. 19, 2006 (JP) 2006-341139

(51) Int. Cl. G02B 5/26

(52) U.S. Cl. 359/839; 359/896

(57) ABSTRACT

A terahertz-band optical component is provided which has extremely high heat resistance and which shows excellent characteristics, such as a coefficient of linear expansion and humidity. A periodic insular pattern is formed on a principal surface of a thin-plate-shaped substrate made of mica as a predetermined conductive pattern. The terahertz-band optical component has extremely high heat resistance and shows excellent characteristics, such as a coefficient of linear expansion and humidity.

This is a continuation of application Serial No. PCT/JP2007/074118, filed Dec. 14, 2007.

### TECHNICAL FIELD

The present invention relates to a terahertz-band optical component which serves as an optical filter for a terahertz band and, more particularly, to an improvement of characteristics based on a new structure.

### BACKGROUND ART

Recently, the terahertz band of about 0.1 to 10 THz (1 THz is 10¹² Hz) has been attracting attention in various fields, such as the medical field including the field of cancer treatment, and various techniques using the terahertz band have been developed.

Terahertz-band optical components, such as filters and polarizers, are necessary to measure or detect the terahertz band. There are various types of terahertz-band optical components, and an example of such a terahertz-band optical component can be manufactured by printing a periodical conductive pattern on a principal surface of a thin substrate.

The thin substrate is required to have a high transmittance for the terahertz-band light. In addition, it is important to avoid interference of the light incident on the substrate (interference of equal inclination). Therefore, it is necessary to select the material and thickness of the substrate such that high transmittance can be obtained and such that the interference can be avoided. However, as described below, it is preferable that the thickness of the substrate is sufficiently small compared to the wavelength.

To ensure the strength and flexibility and to facilitate the manufacturing process, a terahertz-band optical component having the structure shown in FIG. 10 has been proposed in which the thin substrate is made of an organic material, such as paper or plastic.

The figure shows an optical element 110 as an example of a terahertz-band optical component. The optical element has a structure in which lines 114 which reflect electromagnetic waves are periodically arranged on a thin base 112 which transmits electromagnetic waves. The base 112 is made of paper, such as a printer sheet, and the lines 114 are formed of metal, such as aluminum, gold, silver, or copper. The lines 114 are printed on the sheet with an ink containing the metal (see, for example, Patent Document 1). Patent Document 1: Japanese Unexamined Patent Application Publication No. 2004-29153 (claims 1 and 4, paragraphs [0031] to [0035] and [0050], FIG. 1, etc.)

### DISCLOSURE OF INVENTION

### Problems to be Solved by the Invention

In the optical element 110 shown in FIG. 10, which is a known terahertz-band optical component, the thin substrate is made of an organic material, such as paper or plastic. Therefore, the optical element 110 has disadvantages in that (1) heat resistance is low and it is difficult to form the lines 114 in the conductive pattern by metal paste printing and a thermal process; (2) the substrate has a high coefficient of linear expansion and is easily deformed depending on the temperature, and therefore it is difficult to form the lines 114 in the conductive pattern with high precision to obtain desired characteristics with high accuracy; (3) the optical element is vulnerable to humidity and is not suitable for use in high-humidity environments; and (4) the substrate is easily deformed by an external force, and therefore deformation or the like easily occurs in a manufacturing process or while the optical element is used.

In this type of terahertz-band optical component, therefore, it is not adequate to use the substrate made of an organic material, such as paper or plastic. Also for the terahertz waves of around 0.1 to 2.5 THz, which have been attracting considerable attention, it is difficult in practice to use a substrate made of an organic material, such as paper or plastic, in consideration of the interference of equal inclination, the strength, and the like.

An object of the present invention is to provide a new terahertz-band optical component which has extremely high heat resistance and moisture resistance and which shows excellent characteristics, such as a coefficient of linear expansion. In particular, an object of the present invention is to provide a terahertz-band optical component suitable for terahertz waves of around 0.1 to 2.5 THz from a practical point of view. Such a terahertz-band optical component has been difficult to provide by known techniques.

### Means for Solving the Problems

To achieve the above-described objects, a terahertz-band optical component according to the present invention includes a thin-plate-shaped substrate made of mica, and a periodic conductive pattern is formed on a principal surface of the thin-plate-shaped substrate (claim 1).

To prevent the interference of equal inclination, preferably, the thickness t (μm) of the thin-plate-shaped substrate satisfies t≦λ/10 for terahertz waves with a wavelength of λ (μm). In particular, for the terahertz waves of around 0.1 to 2.5 THz, it is practical and preferable that the thickness of the thin-plate-shaped substrate be in the range of 3 to 12 (μm) in consideration of the strength and other factors.

In the case of forming a frequency cut filter, the conductive pattern is preferably a periodic insular pattern. In the case of forming a wire grid, the conductive pattern is preferably a parallel stripe pattern. In addition, in the case of forming a band-pass filter, the conductive pattern is preferably a periodic perforated pattern including insular holes.

### Advantages

According to the invention, instead of using a substrate made of an organic material, such as paper or plastic, the thin-plate-shaped substrate made of mica is used, and the terahertz-band optical component is obtained by forming a period conductive pattern on a principal surface of the thin-plate-shaped substrate.

Mica is a flaky inorganic material, and can be formed into an extremely thin plate-shaped substrate with high heat resistance.

In addition, it has been confirmed through experiments that the thin-plate-shaped substrate made of mica has a high transmittance for terahertz-band light.

The present invention has been made in light of the above-described characteristics of the thin-plate-shaped substrate made of mica. Since the thin-plate-shaped substrate made of mica has a high heat resistance, the conductive pattern on the thin-plate-shaped substrate can be formed by metal paste printing and a heating process. This is not possible in the case where the substrate made of an organic material, such as paper or plastic, is used.

Thus, unlike a substrate made of an organic material, such as paper or plastic, the thin-plate-shaped substrate made of mica has excellent characteristics in that it has a low coefficient of linear expansion and high resistance to humidity, and in that it is not easily deformed by an external force.

Therefore, a new terahertz-band optical component can be provided which has excellent characteristics in that it is thin and has a high heat resistance and sufficient tensile strength. Such a terahertz-band optical component cannot be easily provided when a substrate made of an organic material, such as paper or plastic, is used.

According to a preferred aspect of the invention, a terahertz-band optical component can be provided in which the thickness t (μm) of the thin-plate-shaped substrate made of mica is equal to or less than λ/10 (μm) so that the interference of equal inclination does not occur.

According to another preferred aspect of the invention the thickness of the thin-plate-shaped substrate made of mica is in the range of 3 to 12 (μm). Therefore, a terahertz-band optical component can be provided in which the substrate thickness is set to a most preferable value for the terahertz waves of around 0.1 to 2.5 THz, which have been attracting considerable attention, in consideration of the interference of equal inclination, the strength of the substrate, and other factors.

According to yet another aspect of the invention, the conductive pattern is a periodic insular pattern. Therefore, a terahertz-band optical component formed in a frequency cut filter structure having the effects of the invention can be provided.

The conductive pattern can have a parallel stripe pattern in another aspect. Therefore, a terahertz-band optical component formed in a wire grid structure having the effects of the invention can be provided.

Yet another aspect of the invention has the conductive pattern as a periodic perforated pattern including insular holes. Therefore, a terahertz-band optical component formed in a band-pass filter structure having the effects of the invention can be provided.

### BRIEF DESCRIPTION OF DRAWINGS

FIG. 1 is a schematic perspective view of a terahertz-band optical component according to a first embodiment.

FIG. 2 is an enlarged front view of a part of a principal surface of the terahertz-band optical component shown in FIG. 1.

FIG. 3 is a transmittance characteristic diagram of an example of a thin-plate-shaped mica substrate included in the terahertz-band optical component shown in FIG. 1.

FIG. 4 is a reflectance characteristic diagram of the example of the thin-plate-shaped mica substrate included in the terahertz-band optical component shown in FIG. 1.

FIG. 5 is a transmittance characteristic diagram obtained when the thickness of the thin-plate-shaped mica substrate included in the terahertz-band optical component shown in FIG. 1 is changed.

FIG. 6 is a transmittance characteristic diagram of mica in the terahertz-band optical component shown in FIG. 1.

FIG. 7 is a schematic perspective view of a terahertz-band optical component according to a second embodiment.

FIG. 8 is a transmittance characteristic diagram of the terahertz-band optical component shown in FIG. 7.

FIG. 9 is a schematic perspective view of a part of a terahertz-band optical component according to a third embodiment.

FIG. 10 is a diagram illustrating an example of a known structure.

### REFERENCE NUMERALS

1a, 1b, 1c: terahertz-band optical component

2: thin-plate-shaped substrate

2a: principal surface

4: insular pattern

5: perforated pattern

8: stripe

9: vertical stripe pattern

### Best Modes for Carrying Out the Invention

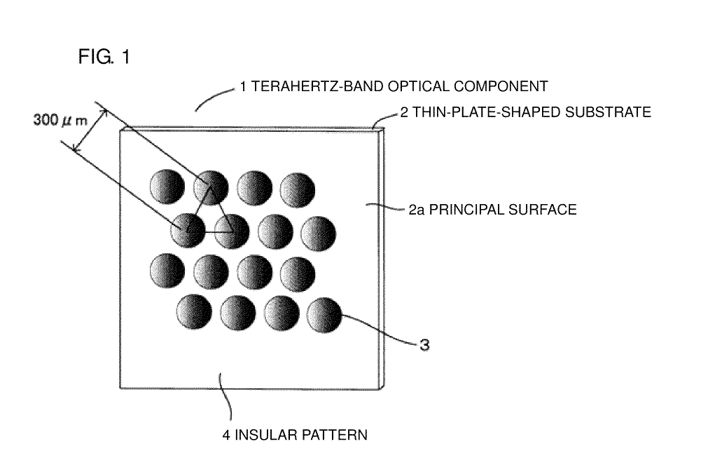

To describe the present invention in more detail, embodiments will be described with reference to FIGS. 1 to 9.

### First Embodiment

A first embodiment will be described with reference to FIGS. 1 to 6.

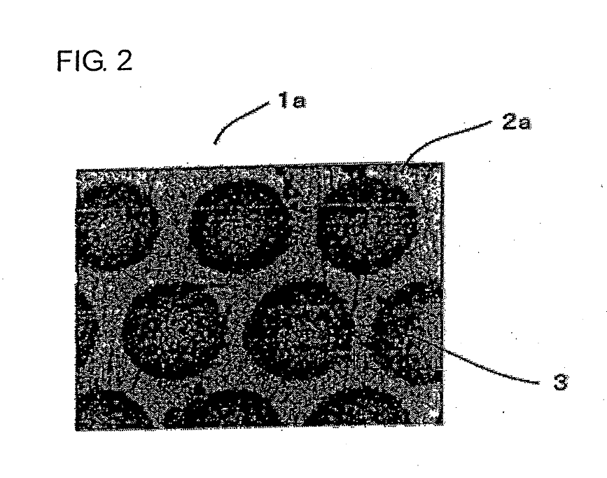

FIG. 1 illustrates a terahertz-band optical component 1a formed in the structure of a specific-frequency cut filter. FIG. 2 is an enlarged front view of a part of a principal surface of the terahertz-band optical component 1a. In FIG. 1, the insular pattern, which will be described below, is exaggerated and is shown in dimensions different from those in the actual dimensional relationship.

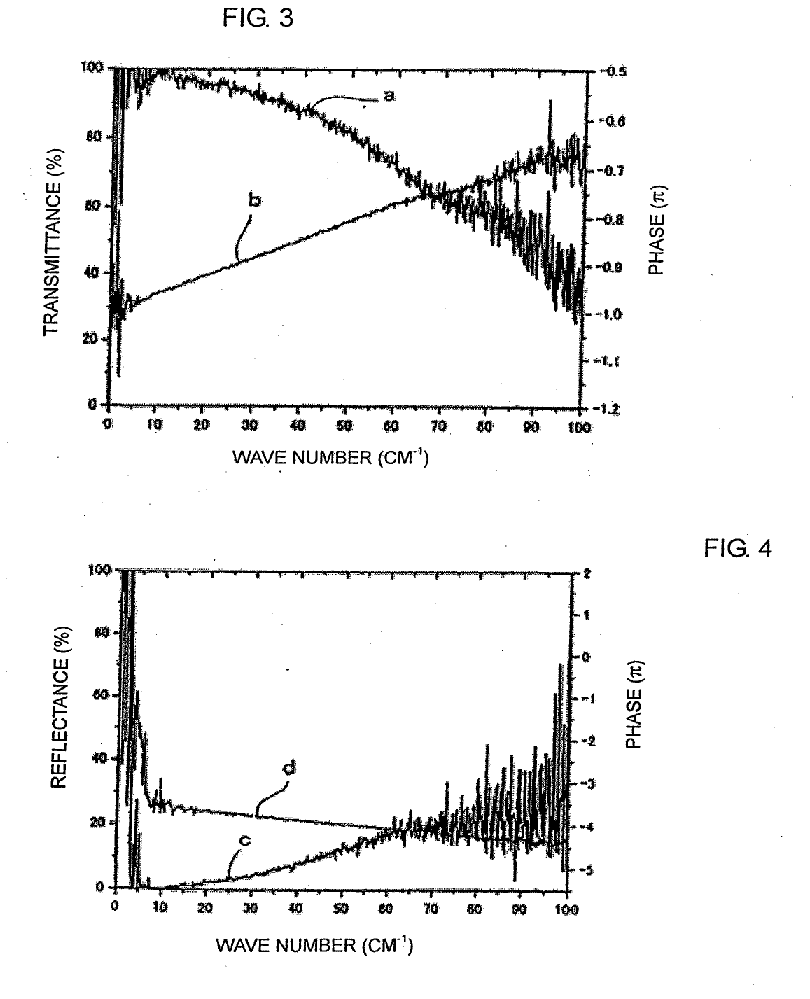

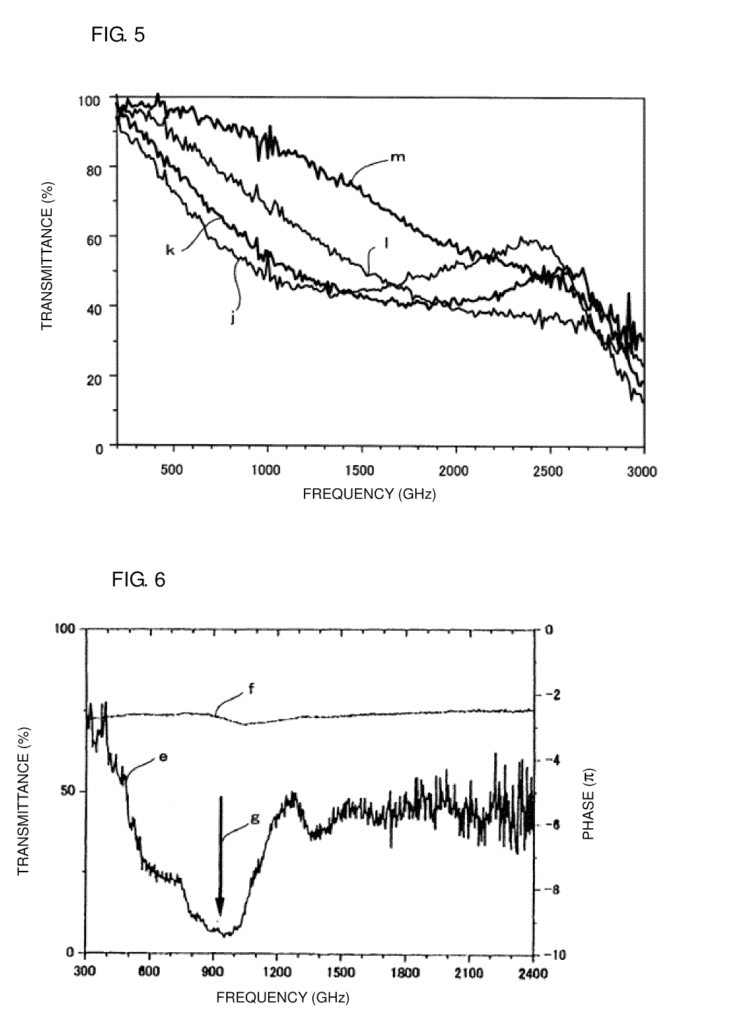

FIGS. 3 and 4 show the transmittance characteristics and the reflectance characteristics, respectively, of an example of a thin-plate-shaped substrate 2 included in the terahertz-band optical component 1a. FIGS. 5 ad 6 show the transmittance characteristics of the terahertz-band optical component 1a.

The terahertz-band optical component 1a shown in FIG. 1 is formed in the structure of a specific-frequency cut filter which cuts off a specific frequency in the terahertz band. The thin-plate-shaped substrate 2 included in the terahertz-band optical component 1a is made of white mica [KAl₂(Si₃Al)O₁₀(OH)₂]. A periodic insular pattern 4 including silver circular dots 3 arranged in a scattered manner is formed on a principal surface 2a of the thin-plate-shaped substrate 2 as a predetermined conductive pattern. The structure, etc., will be described below.

### (Thin-Plate-Shaped Substrate 2)

First, the thin-plate-shaped substrate 2 will be described.

Micas including the above-mentioned white mica are a flaky inorganic material, and can be formed into an extremely thin plate-like form with high optical transmittance and high heat resistance. Unlike substrates made of an organic material, such as paper or plastic, substrates made of mica have excellent characteristics in that they have a low coefficient of linear expansion and high resistant to humidity and in that they are not easily deformed by an external force. The melting point of mica is about 1200° C. Natural mica is dehydrated at 700° C. to 800° C., but is said to be extremely stable when the temperature is 700° C. or less.

The size of the thin-plate-shaped substrate 2 made of white mica is 10 cm square, that is, 10 cm (longitudinal)×10 cm (lateral), which is a basic size suitable for mass production of the filters of this type.

The thickness of the thin-plate-shaped substrate 2 is set as follows.

When t (μm) is the thickness of the thin-plate-shaped substrate 2, λ (μm) is the wavelength of light, n(λ) is the refractive index of mica, and ε(λ) is the dielectric constant of mica, as is well known, the basic expression of the thickness t for preventing the light from causing the interference of equal inclination at the thin-plate-shaped substrate 2 can be obtained as in expression (1) given below. In addition, the dielectric constant ε(λ) can be expressed as in expression (2).

### Expression 1

0<t≦λ/(4×n(λ)) (1)

### Expression 2

68 (λ)={n(λ)}² (2)

As is well known, the dielectric constant ε(λ) of mica is 6.5 (reference value) in the microwave band. In addition, it has been confirmed through experiments that the dielectric constant ε(λ) of mica is 7 (measured value) in a terahertz band.

Therefore, it is adequate to set the refractive index n(λ) of mica in the terahertz band to 2.5. Accordingly, by substituting n(λ)=2.5 into expression (1), it is found that the interference of equal inclination of terahertz waves at the thin-plate-shaped substrate 2 can be prevented by setting the thickness of the thin-plate-shaped substrate 2 such that expression (3) given below is satisfied.

### Expression 3

0<t≦λ/10 (3)

Thus, the interference of equal inclination of terahertz waves with a wavelength of λ (μm) can be prevented by setting the thickness of the thin-plate-shaped substrate 2 to a thickness t (μm) that is equal to or less than λ/10.

From the practical viewpoint, the thickness of the thin-plate-shaped substrate 2 is preferably comprehensively determined in consideration of strength and other factors instead of setting the thickness of the thin-plate-shaped substrate 2 in consideration only of the interference of equal inclination.

According to the present embodiment, the thickness of the thin-plate-shaped substrate 2 is set to t=3 to 12 μm, as described below, for the terahertz waves of about 0.1 to 2.5 THz (wavelength λ=300 to 120 μm), which have been attracting considerable attention.

First, the thin-plate-shaped substrate 2 having a thickness of 8 μm was prepared, and the transmittance characteristics and the reflectance characteristics for the terahertz-band light were measured using a well-known terahertz time-domain spectroscopy method called “THz-TDS method.” As a result, the transmittance characteristics shown in FIG. 3 and the reflectance characteristics shown in FIG. 4 were obtained. In FIG. 3, the solid lines a and b respectively show the transmittance characteristics and the phase characteristics of the transmitted light with respect to the wave number. In FIG. 4, the solid lines c and d respectively show the reflectance characteristics and the phase characteristics of the reflected light with respect to the wave number.

It is clear from the experiment results shown in FIGS. 3 and 4 that the thin-plate-shaped substrate 2 made of mica shows high transmittance for the terahertz band when the thickness thereof is smaller than around 10 μm. Thus, it can be said that the thin-plate-shaped substrate 2 made of mica is suitable for the terahertz band of around 0.1 THz (3.3 cm⁻¹ in wave number) to 2.5 THz (83 cm⁻¹ in wave number and 120 μm in wavelength).

According to the condition of expression (3), that is, 0<t≦λ/10, for preventing the interference of equal inclination of the terahertz waves of 2.5 THz or less, the upper limit of the thickness of the thin-plate-shaped substrate 2 is set to 12 μm. From the practical viewpoint, the upper limit of the thickness of the thin-plate-shaped substrate 2 for the terahertz waves of substantially 2.5 THz or less is set to 12 μm.

In addition, the lower limit of the thickness of the thin-plate-shaped substrate 2 is considered to be about 3 μm in consideration of the peeling limit and the strength of mica.

Thin-plate-shaped substrates 2 with the thicknesses of 23 μm, 18 μm, 12 μm, and 4 μm were made from a single piece of white mica, and the transmittances thereof were measured by the THz-TDS method. The result is shown in FIG. 5. In the figure, the solid lines j, k, l, and m show the transmittance characteristics for the thicknesses of 23 μm, 18 μm, 12 μm, and 4 μm, respectively. The transmittances obtained when the thickness is 23 μm and 18 μm have peaks, and this is due to the interference of equal inclination. As the wavelength is reduced, the peak position shifts toward the high-frequency side. When the thickness is equal to or less than 12 μm, no peak is observed in the range of 0.1 to 2.5 THz, which has been attracting considerable attention, and thus the influence of the interference of equal inclination can be eliminated in this range. Therefore, in the present embodiment, the thickness of the thin-plate-shaped substrate 2 is set to an adequate thickness in the range of 3 to 12 μm, which is suitable for the terahertz waves in the range of 0.1 THz to 2.5 THz. More specifically, the thickness is set to 8 μm as described above.

The thin-plate-shaped substrate 2 having a rectangular shape of 10 cm×10 cm and a thickness t of 8 μm is formed by peeling a piece of white mica using a jig.

### (Insular Pattern 4)

The above-described insular pattern 4, which serves as a conductive pattern, will now be described.

Since the thin-plate-shaped substrate 2 has high heat resistance, the silver circular dots 3 in the periodical insular pattern 4, which serves as the conductive pattern, can be formed by a practical method suitable for mass production, that is, by printing a metal paste on the principal surface 2a of the thin-plate-shaped substrate 2 on, for example, the incident side and subjecting the metal paste to a heating process.

To cut, for example, a frequency of 1 THz, the diameter of the circular dots 3 is set to 200 μm and the circular dots 3 are arranged in an equilateral triangular grid pattern with a 300-μm pitch, as shown in FIG. 1.

Next, an actual method for forming the insular pattern will be described.

First, a metal mask in which 200-μm-diameter holes are formed in an equilateral triangular grid pattern with a 300-μm pitch is prepared.

Then, the metal mask is brought into close contact with a principal surface 2a of the thin-plate-shaped substrate 2 made of white mica, and a silver paste is applied in this state. The metal mask is removed from the thin-plate-shaped substrate 2 so that the circular dots 3 made of silver paste are printed on the principal surface 2a of the thin-plate-shaped substrate 2 in a scattered manner.

Next, the thin-plate-shaped substrate 2 on which the circular dots 3 made of silver paste are printed in a scattered manner is put into an oven and is heated, for example, at 300° C. for an hour. In this process, as shown in the enlarged view in FIG. 2, the circular dots 3 strongly adhere to the thin-plate-shaped substrate 2.

(Characteristics of Terahertz-Band Optical Component 1a)

The transmittance characteristics of the terahertz-band optical component 1a formed by the above-described process were measured by the above-mentioned “THz-TDS method.” As a result, the measurement result shown in FIG. 6 was obtained. In FIG. 6, the solid lines e and f respectively show the transmittance characteristics and the phase characteristics of the transmitted light with respect to the frequency.

As is clear from FIG. 6, the terahertz-band optical component 1a with the circular dots 3 absorbs a frequency of substantially 1000 GHz (=1 THz), which is shown by the arrow g in the figure. Thus, a specific-frequency cut filter for the terahertz band which adequately cuts a frequency of 1 THz is obtained.

In addition, the temperature dependence of the terahertz-band optical component 1a in the range of −25° C. to 75° C. was measured. The result is shown in Table 1.

TABLE 1

| Temperature | −25° C. | 0° C. | 25° C. | 75° C. |
|---|---|---|---|---|
| Cut Frequency | 0.96 THz | 0.95 THz | 0.95 THz | 0.93 THz |

As is clear from Table 1, the cut frequency of the terahertz-band optical component 1a hardly varies in the range of −25° C. to 75° C., and the temperature coefficient is 0.3 GHz/° C. Thus, it was found that the temperature dependence is extremely low.

In the present embodiment, instead of using a substrate made of an organic material, such as paper or plastic, the thin-plate-shaped substrate 2 made of white mica, which has a high transmittance for the terahertz-band light and a high heat resistance, is used. Therefore, the insular pattern 4, which serves as a conductive pattern, can be formed on the substrate 2 by metal paste printing and the heating process, and thus a frequency cut filter structure can be obtained. This is not possible in the case where the substrate made of an organic material, such as paper or plastic, is used.

The size of the thin-plate-shaped substrate 2 is set to 10 cm×10 cm, which is suitable for silver paste printing. Thus, the pattern 4 can be easily formed at low cost with high precision by silver paste printing.

In addition, unlike the substrate made of an organic material, such as paper or plastic, the thin-plate-shaped substrate 2 has excellent characteristics in that it has a low coefficient of linear expansion and high resistance to humidity and in that it is not easily deformed by an external force.

Accordingly, the terahertz-band optical component la has excellent characteristics in that it is thin and has a high heat resistance, a low coefficient of linear expansion, and sufficient tensile strength. Such a terahertz-band optical component cannot be easily provided when the substrate made of an organic material, such as paper or plastic, is used. In addition, the terahertz-band optical component 1a can be easily formed at low cost with high precision.

### Second Embodiment

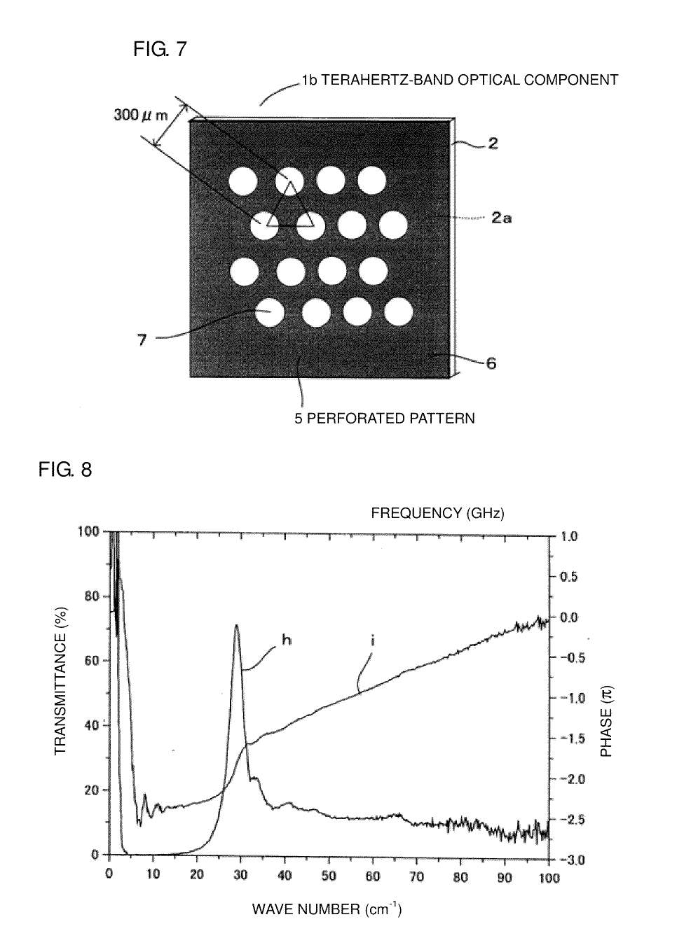

A second embodiment will be described with reference to FIGS. 7 and 8.

FIG. 7 illustrates a terahertz-band optical component 1b formed in the structure of a band-pass filter. FIG. 8 shows the transmittance characteristics of the terahertz-band optical component lb. In FIG. 7, the perforated pattern, which will be described below, is exaggerated and is shown in dimensions different from those in the actual dimensional relationship.

In FIG. 7, components which are the same as or similar to those shown in FIG. 1 are denoted by the same reference numerals. The terahertz-band optical component 1b shown in this figure includes a thin-plate-shaped substrate 2 made of white mica, and is formed in the structure of a band-pass filter which allows a predetermined frequency in the terahertz band to pass therethrough. The difference between the terahertz-band optical component 1b and the terahertz-band optical component 1a shown in FIG. 1 is in the following points. That is, instead of the insular pattern 4 including the circular dots 3 shown in FIG. 1, a perforated pattern 5 including periodically arranged insular holes is formed on the principal surface 2a of the thin-plate-shaped substrate 2 as a conductive pattern.

To form a band-pass filter for a frequency of 1 THz, the perforated pattern 5 is formed such that 200-μm-diameter holes 7 are formed in a scattered manner in an aluminum thin film 6 in an equilateral triangular grid pattern with a 300-μm pitch, as shown in FIG. 7.

Next, an actual method for forming the perforated pattern 5 will be described.

First, the thin-plate-shaped substrate 2 having a 10-cm square shape with a thickness of 8 μm is prepared, and resist is applied to the principal surface 2a of the thin-plate-shaped substrate 2. Then, a resist pattern including 200-μm-diameter dots is formed by lithography.

Then, aluminum is deposited onto the surface of the resist pattern, and unnecessary portions are removed together with the photoresist in a lift-off process. Thus, the perforated pattern 5 is formed.

Then, the thin-plate-shaped substrate 2 in which the perforated pattern 5 is formed is heated to, for example, 120° C.

The transmittance characteristics of the terahertz-band optical component 1b formed by the above-described process were measured by the above-mentioned “THz-TDS method.” As a result, the measurement result shown in FIG. 8 was obtained. In FIG. 8, the solid lines h and i respectively show the transmittance characteristics and the phase characteristics of the transmitted light with respect to the wave number.

As is clear from FIG. 8, the terahertz-band optical component 1b serves as a good band-pass filter in which the transmittance for 1 THz is 70% and a half bandwidth is 300 GHz.

Thus, instead of using a substrate made of an organic material, such as paper or plastic, the thin-plate-shaped substrate 2 made of white mica, which has a high transmittance for the terahertz-band light and a high heat resistance, is used in the present embodiment. Therefore, the perforated pattern 5, which serves as a conductive pattern, can be formed on the substrate 2 by the process of heating a deposited metal film. In this way, the conductive pattern can be easily formed at low cost with high precision and thus a band-pass filter structure can be obtained. This is not possible in the case where the substrate made of an organic material, such as paper or plastic, is used.

In addition, unlike the substrate made of an organic material, such as paper or plastic, the thin-plate-shaped substrate 2 has excellent characteristics in that it has a low coefficient of linear expansion and high resistance to humidity and in that it is not easily deformed by an external force. Accordingly, the terahertz-band optical component 1b also has excellent characteristics that it is thin and has a high heat resistance, a low coefficient of linear expansion, and sufficient tensile strength. Such a terahertz-band optical component cannot be easily provided when the substrate made of an organic material, such as paper or plastic, is used. In addition, the terahertz-band optical component 1b can be easily formed at low cost with high precision.

### Third Embodiment

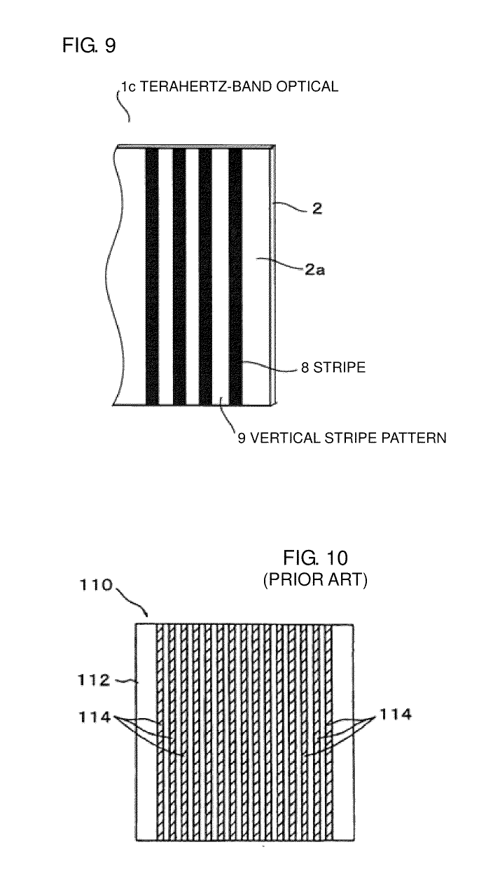

A third embodiment will be described with reference to FIG. 9.

FIG. 9 is a perspective view of a portion of a terahertz-band optical component 1c formed in a wire grid structure. In the figure, a vertical stripe pattern, which will be described below, is exaggerated and is shown in dimensions different from those in the actual dimensional relationship.

The terahertz-band optical component 1c shown in FIG. 9 includes a thin-plate-shaped substrate 2 made of white mica, and is formed in a structure which serves as a polarizer at, for example, around 0.1 to 0.5 THz in the terahertz band.

More specifically, the thin-plate-shaped substrate 2 made of white mica and a metal mask in which vertical stripe-shaped holes having a width of 50 μm are arranged parallel to each other at a pitch of 200 μm are prepared. Then, the metal mask is brought into close contact with the principal surface 2a of the thin-plate-shaped substrate 2, and a silver paste is applied in this state. Then, the metal mask is removed from the thin-plate-shaped substrate 2 so that a vertical stripe pattern 9 including vertical stripes made of silver paste are formed on the principal surface 2a of the thin-plate-shaped substrate 2. Then, the thin-plate-shaped substrate 2 on which the vertical stripe pattern 9 is formed is put into an oven and is heated, for example, at 300° C. for an hour. Thus, the terahertz-band optical component 1c is obtained.

The transmittance characteristics of the terahertz-band optical component 1c formed by the above-described process were measured by the above-mentioned “THz-TDS method.” As a result, it was confirmed that the terahertz-band optical component 1c serves as a polarizer at 0.1 to 0.3 THz.

Also in the present embodiment, instead of using a substrate made of an organic material, such as paper or plastic, the thin-plate-shaped substrate 2 made of white mica, which has a high transmittance for the terahertz-band light and a high heat resistance, is used. Therefore, the vertical stripe pattern 9, which serves as a conductive pattern, can be formed on the substrate 2 by the process of heating the metal pattern. In this way, the conductive pattern can be easily formed at low cost with high precision and a wire grid structure can be obtained. This is not possible in the case where a substrate made of an organic material, such as paper or plastic, is used.

In addition, unlike a substrate made of an organic material, such as paper or plastic, the thin-plate-shaped substrate 2 has excellent characteristics in that it has a low coefficient of linear expansion and high resistant to humidity, and in that it is not easily deformed by an external force. Accordingly, the terahertz-band optical component 1c also has excellent characteristics that it is thin and has a high heat resistance, a low coefficient of linear expansion, and sufficient tensile strength. Such a terahertz-band optical component cannot be easily provided when a substrate made of an organic material, such as paper or plastic, is used. In addition, the terahertz-band optical component 1c can be easily formed at low cost with high precision.

The present invention is not limited to the above-described embodiments, and various modifications are possible within the scope of the present invention. For example, the mica used as the material of the thin-plate-shaped substrate 2 is not limited to white mica, and phlogopite [K(Mg,Fe)₃(Si₃Al)O₁₀(OH)₂] and synthetic mica [fluorphlogopite KMg₃(Si₃Al)O₁₀F₂, K-fluor-tetrasilicic mica KMg_{2.5}Si₄O₁₀F₂] may also be used.

The size and the shape of the principal surface of the thin-plate-shaped substrate 2 are not particularly limited. However, from the practical viewpoint, the thin-plate-shaped substrate 2 is preferably formed in a typical shape suitable for mass production with an adequate size, for example, in a 10-cm square as described above. To form the thin-plate-shaped substrate 2 in such a size, the material of the thin-plate-shaped substrate 2 may be limited to white mica and synthetic mica in practice.

In addition, depending on the use and function of the terahertz-band optical component, the principal surface 2a of the thin-plate-shaped substrate 2 may also be the principal surface on the exit side.

In addition, the shape, the size, the arrangement, etc., of the periodic conductive pattern may be adequately set in accordance with the intended use and the like of the terahertz-band optical component. For example, the shape of the dots in the insular pattern 4 on the terahertz-band optical component 1a and the shape of the holes in the perforated pattern 5 on the terahertz-band optical component 1a are not limited to the circular shape, and may also be, for example, rectangular. In addition, the pitch and the like in the patterns 4 and 5 may be set to adequate values in accordance with the desired frequency characteristics.

In addition, the thickness of the thin-plate-shaped substrate 2 is not particularly limited as long as the condition of expression (3) is satisfied, and is not limited to the range of 3 to 12 μm for the terahertz waves of 0.1 to 2.5 THz.

In addition, the conductive pattern may, of course, be formed by various conductive materials including metals, metal compounds, etc., and the method for manufacturing the conductive pattern is not limited to the methods described in the above-described embodiments.

### INDUSTRIAL APPLICABILITY

The present invention can be applied to terahertz-band optical components having various functions and characteristics.

1. A terahertz-band optical component comprising a thin-plate-shaped mica substrate having a periodic conductive pattern formed on a principal surface of the thin-plate-shaped substrate.

2. The terahertz-band optical component according to claim 1, wherein the thin-plate-shaped substrate has a thickness t (μm) of 0<t≦λ/10, in which λ (μm) is a wavelength of the terahertz-band light.

3. The terahertz-band optical component according to claim 1, wherein the thickness of the thin-plate-shaped substrate is in the range of 3 to 12 (μm).

4. The terahertz-band optical component according to claim 3, wherein the conductive pattern is a periodic insular pattern.

5. The terahertz-band optical component according to claim 3, wherein the conductive pattern is a parallel stripe pattern.

6. The terahertz-band optical component according to claim 3, wherein the conductive pattern is a periodic perforated pattern including insular holes.

7. The terahertz-band optical component according to claim 2, wherein the conductive pattern is a periodic insular pattern.

8. The terahertz-band optical component according to claim 2, wherein the conductive pattern is a parallel stripe pattern.

9. The terahertz-band optical component according to claim 2, wherein the conductive pattern is a periodic perforated pattern including insular holes.

10. The terahertz-band optical component according to claim 1, wherein the conductive pattern is a periodic insular pattern.

11. The terahertz-band optical component according to claim 1, wherein the conductive pattern is a parallel stripe pattern.

12. The terahertz-band optical component according to claim 1, wherein the conductive pattern is a periodic perforated pattern including insular holes.

13. The terahertz-band optical component according to claim 1, wherein the mica is white mica.

14. The terahertz-band optical component according to claim 13, wherein the thickness of the thin-plate-shaped substrate is in the range of 3 to 12 (μm).

15. The terahertz-band optical component according to claim 14, wherein the conductive pattern is a periodic insular pattern.

16. The terahertz-band optical component according to claim 14, wherein the conductive pattern is a parallel stripe pattern.

17. The terahertz-band optical component according to claim 14, wherein the conductive pattern is a periodic perforated pattern including insular holes.

18. The terahertz-band optical component according to claim 1, wherein the mica is synthetic mica.

19. The terahertz-band optical component according to claim 18, wherein the thickness of the thin-plate-shaped substrate is in the range of 3 to 12 (μm).
